(19) United States
(12) Patent Application Publication
(10) Pub. No.: US 2005/0093424 A1
(43) Pub. Date: May 5, 2005

(54) Field emission display device

(75) Inventor: Seong-Hak Moon, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/977,927

(22) Filed: Oct. 28, 2004

(30) Foreign Application Priority Data
Nov. 3, 2003 (KR) 77362/2003
Nov. 4, 2003 (KR) 77611/2003

(51) Int. Cl. H01J 1/62; H01J 63/04

(52) U.S. Cl. 313/495

(57) ABSTRACT

The present invention discloses a field emission display device which can improve luminance of a field emission display, prevent crosstalk between neighboring cells of the field emission display, and lower a driving voltage by narrowing an interval between electrodes. The field emission display device includes a single cathode electrode positioned at the center of the field emission display device and formed on an insulation layer, gate electrodes formed in via holes formed on the insulation layer, and carbon nano tubes formed on both surfaces of the single cathode electrode, respectively.

### BACKGROUND OF THE INVENTION

1. Field of the Invention

The present invention relates to a field emission display (FED), and more particularly to, an FED device.

2. Description of the Prior Art

According to rapid development of the information and communication technologies, demands for a display have increased and the structure of the display has been diversified. For example, when an information device is a portable information communication device having mobility, a small light display showing low power consumption is necessary, and when an information device is a general information transmission medium, a display having a large screen such as a cathode ray tube (CRT), a liquid crystal display (LCD), a plasma display panel (PDP) and a vacuum fluorescent display (VFD) is necessary. Accordingly, an FED characterized by a small size, low power consumption and high resolution has been actively developed.

The FED is considered as a flat panel display for next generation information and communication which overcomes disadvantages of the developed or mass-produced flat panel displays (for example, LCD, PDP and VFD). An FED device is simple in electrode structure and operated at a high speed like the CRT. Also, the FED device takes advantages of the display, such as unlimited.

On the other hand, an FED device having a carbon nano tube has been generally used. The carbon nano tube is mechanically strong, chemically stable, and has excellent electron emission characteristics in a low vacuum degree. Since the carbon nano tube has a small diameter (about 1.0 to a few tens nm), it shows a higher field enhancement factor than an emitter having a micro-tip, thereby emitting electrons by a low turn-on field (about 1 to 5V/μm). As the carbon nano tube is applied to the FED device, power loss and the unit cost of production of the FED device are reduced.

The structure of the conventional FED device having the carbon nano tube will now be explained with reference to FIG. 1.

FIG. 1 is a cross-sectional diagram illustrating the structure of the conventional FED device having the carbon nano tube.

Referring to FIG. 1, the conventional FED device having the carbon nano tube includes an anode electrode 21 formed on an upper glass substrate 20, a phosphor layer 22 formed on the anode electrode 21, a cathode electrode 12 and a gate electrode 11 formed on the same plane surface of a lower glass substrate 10, and a carbon nano tube 13 formed on part of the cathode electrode 12. Here, the cathode electrode 12 and the gate electrode 11 are formed on the same plane surface of the lower glass substrate 10.

After a high voltage is applied to the anode electrode 21, when a threshold voltage is applied to the gate electrode 11 and the cathode electrode 12, electrons (electron beams) generated at one edge of the carbon nano tube 13 formed on the cathode electrode 12 are curved in the gate electrode direction and emitted in the anode electrode direction. The electrons (electron beams) emitted in the anode electrode direction are accelerated by the high voltage applied to the anode electrode 21, to collide against the phosphor layer 22 formed on the anode electrode 21. Here, the phosphor layer 22 is excited by the electron beams, to emit visible rays.

However, the electron beams emitted from the carbon nano tube 13 may be distorted when emitted in the anode electrode direction. If the electron beams are distorted, crosstalk occurs between neighboring cells, and contrast of images is deteriorated.

When the electron beams emitted from the carbon nano tube 13 are distorted, the electron beams are emitted to part of the phosphor layer 22, thereby reducing uniformity of screen. Especially, the general FED device uses the electron beams generated at one edge of the carbon nano tube 13, and thus the electron beams are curved merely in one direction. Therefore, the phosphor layer 22 is partially excited, to deteriorate luminance and uniformity.

A matrix structure of a conventional FED having the FED device will now be described with reference to FIG. 2.

FIG. 2 is a plane diagram illustrating one example of the matrix structure of the conventional FED.

As shown in FIG. 2, the FED includes a plurality of scan lines Scan 1 to Scan N, a plurality of data lines D₁ to Dₘ formed to cross the plurality of scan lines Scan 1 to Scan N, and FED devices formed at the cross regions between each scan line (for example, Scan 1) and each data line (for example D₁). Here, one FED device is installed in each of a red pixel, a green pixel and a blue pixel. The gate electrode 11 of the FED device is electrically connected to the data line (for example D₁), and the cathode electrode 12 of the FED device is electrically connected to the scan line (for example, Scan 1).

For example, the carbon nano tube 13 formed on the FED device is formed on part of the cathode electrode 12, and the gate electrode 11 is disposed separately from the cathode electrode 13. Accordingly, the electron beams emitted from one edge of the carbon nano tube 13 are curved in the gate electrode direction and emitted in the anode electrode direction. That is, the electron beams are emitted in the anode electrode direction in a parabola shape, to reach the neighboring cells (FED devices).

As described above, the conventional FED device having the carbon nano tube reduces luminance, by separately arranging the gate electrode and the cathode electrode, forming the carbon nano tube on the cathode electrode, and emitting the electron beams from one edge of the carbon nano tube. Since the distorted electron beams reach the phosphor layer, crosstalk occurs between the neighboring cells. Moreover, the distorted electron beams partially excite the phosphor layer, to deteriorate uniformity of screen.

On the other hand, the conventional FED device has been disclosed under U.S. Pat. Nos. 6,169,372, 6,646,282 and 6,672,926.

### SUMMARY OF THE INVENTION

Therefore, an object of the present invention is to provide a field emission display device which can improve luminance of a field emission display.

Another object of the present invention is to provide a field emission display device which can prevent crosstalk between neighboring cells of a field emission display.

Yet another object of the present invention is to provide a field emission display device which can lower a driving voltage by narrowing an interval between electrodes.

To achieve these and other advantages and in accordance with the purpose of the present invention, as embodied and broadly described herein, there is provided a field emission display device, including: an anode electrode formed on a first substrate; a phosphor layer formed on the anode electrode; a cathode electrode line formed on a second substrate; an insulation layer formed on the cathode electrode line; a gate electrode formed on the insulation layer; cathode electrodes connected to the cathode electrode line exposed through via holes formed on the insulation layer; and carbon nano tubes formed on the cathode electrodes, respectively.

According to another aspect of the present invention, a field emission display device includes: an anode electrode formed on a first substrate; a phosphor layer formed on the anode electrode; a cathode electrode line formed on a second substrate; an insulation layer formed on the cathode electrode line; a gate electrode positioned at the center of the field emission display device, and formed on the insulation layer; a first cathode electrode connected to the cathode electrode line exposed through a first via hole formed on the insulation layer; a second cathode electrode connected to the cathode electrode line exposed through a second via hole formed on the insulation layer; a first carbon nano tube formed on the first cathode electrode; and a second carbon nano tube formed on the second cathode electrode.

According to yet another aspect of the present invention, a field emission display device includes: a gate electrode line and an insulation layer sequentially formed on a lower glass substrate; gate electrodes formed on the insulation layer, and connected to the gate electrode line exposed through via holes formed on the insulation layer; a cathode electrode formed on the insulation layer, and disposed at the center of the field emission display device between the gate electrodes; a first carbon nano tube formed on the right surface of the cathode electrode; and a second carbon nano tube formed on the left surface of the cathode electrode.

According to yet another aspect of the present invention, a field emission display device includes: a single gate electrode positioned at the center of the field emission display device, and formed on an insulation layer; cathode electrodes formed in via holes formed on the insulation layer; and carbon nano tubes formed on the cathode electrodes, respectively.

According to yet another aspect of the present invention, a field emission display device includes: a single cathode electrode positioned at the center of the field emission display device, and formed on an insulation layer; gate electrodes formed in via holes formed on the insulation layer; and carbon nano tubes formed on both surfaces of the single cathode electrode, respectively.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional diagram illustrating a structure of a conventional FED device having a carbon nano tube;

FIG. 2 is a plane diagram illustrating an example of a matrix structure of a conventional FED;

FIG. 3 is a cross-sectional diagram illustrating a structure of an FED device in accordance with a first embodiment of the present invention;

FIG. 4 is a plane diagram illustrating a matrix structure of an FED in accordance with the first embodiment of the present invention;

FIG. 5 is an enlarged diagram illustrating a formation part of first and second carbon nano tubes of FIG. 4;

FIG. 6 is a cross-sectional diagram illustrating a structure of an FED device in accordance with a second embodiment of the present invention;

FIG. 7 is a cross-sectional diagram illustrating electron beams emitted from carbon nano tubes of the FED device in accordance with the second embodiment of the present invention; and

FIG. 8 is a plane diagram illustrating a matrix structure of an FED having the FED device in accordance with the second embodiment of the present invention.

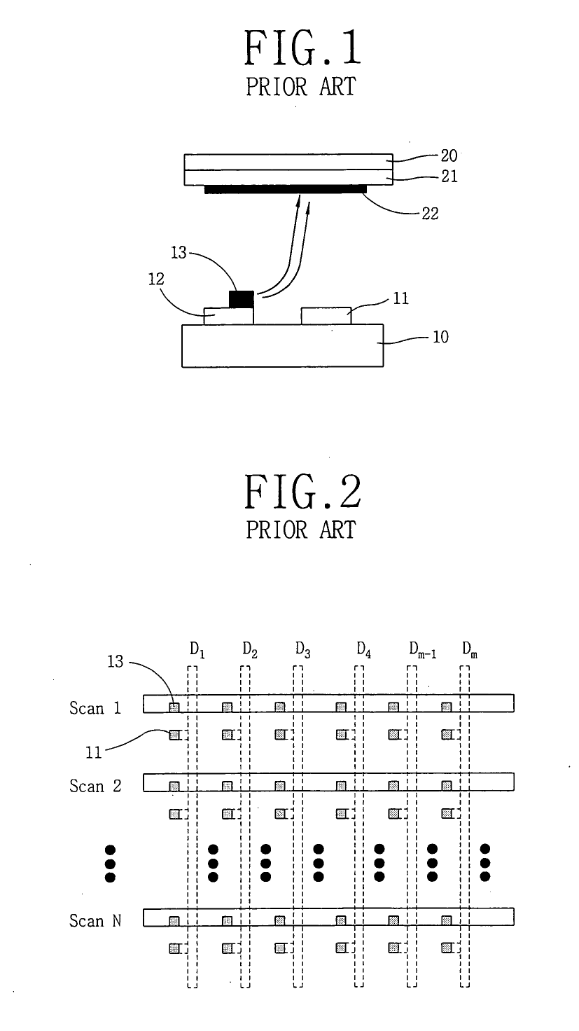

### DETAILED DESCRIPTION OF THE PREFERRED EMBODIMENTS

Reference will now be made in detail to the preferred embodiments of the present invention, examples of which are illustrated in the accompanying drawings.

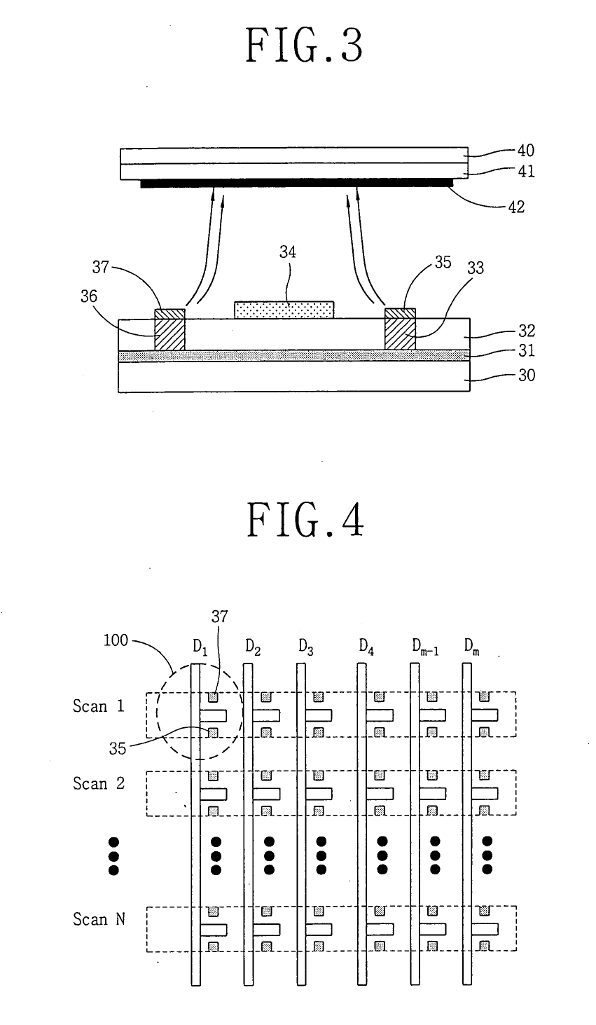

An FED device which can prevent crosstalk between neighboring cells, improve luminance, and lower a driving voltage by narrowing an interval between electrodes, by forming a single gate electrode between a plurality of cathode electrodes or a single cathode electrode between a plurality of gate electrodes, and forming a carbon nano tube on the single cathode electrode or a plurality of carbon nano tubes on the plurality of cathode electrodes will now be described in detail with reference to FIGS. 3 to 8.

FIG. 3 is a cross-sectional diagram illustrating a structure of an FED device in accordance with a first embodiment of the present invention.

As illustrated in FIG. 3, the FED device includes an anode electrode 41 formed on an upper glass substrate 40, a phosphor layer 42 formed on the anode electrode 41, a cathode electrode line 31 formed on a lower glass substrate 30, an insulation layer 32 formed on the cathode electrode line 31, a gate electrode 34 positioned at the center of the FED device (cell), and formed on the insulation layer 32, a first cathode electrode 33 electrically connected to the cathode electrode line 31 exposed through a first via hole formed on the insulation layer 32, and formed in the first via hole, a second cathode electrode 36 electrically connected to the cathode electrode line 31 exposed through a second via hole formed on the insulation layer 32, and formed in the second via hole, a first carbon nano tube 35 formed on the first cathode electrode 33, and a second carbon nano tube 37 formed on the second cathode electrode 36.

The gate electrode 34 is formed between the first cathode electrode 33 and the second cathode electrode 36. In addition, the gate electrode 34 is formed between the first carbon nano tube 35 and the second carbon nano tube 37. That is, the first carbon nano tube 35 and the second carbon nano tube 37 are formed at the left and right sides of one gate electrode 34. That cathode electrode line 31 is formed under the gate electrode 34.

The structure of the FED device in accordance with the first embodiment of the present invention will now be explained in detail.

The cathode electrode line 31 is disposed on the lower glass substrate 30, and the insulation layer 32 is formed on the cathode electrode line 31. The gate electrode 34 is arranged at the center of the cell (FED device) that is the center of the insulation layer 32.

The first cathode electrode 33 is formed in the first via hole of the insulation layer 32, and the second cathode electrode 36 is formed at the second via hole of the insulation layer 32. Accordingly, the thickness of the first and second cathode electrodes 33 and 36 is identical to that of the insulation layer 32. Preferably, the first and second cathode electrodes 33 and 36 are formed in the first and second via holes and leveled.

The first carbon nano tube 35 and the second carbon nano tube 37 are formed on the same plane surface as that of the gate electrode 34. For example, the first carbon nano tube 35 and the second carbon nano tube 37 are formed on the first and second cathode electrodes 33 and 36 formed in the first and second via holes of the insulation layer 32, respectively. Here, the first and second cathode electrodes 33 and 36 are electrically connected to the cathode electrode line 31 exposed through the first and second via holes.

According to remarkable characteristics of the FED device in accordance with the first embodiment of the present invention, since the first carbon nano tube 35 and the second carbon nano tube 37 are disposed at the left and right sides of the gate electrode 34, more electrons are generated at the edges of the first carbon nano tube 35 and the second carbon nano tube 37. The increased electrons (electron beams) are curved in the gate electrode direction positioned at the center of the cell, to collide against the phosphor layer 42. That is, as known from a locus of the electron beams in FIG. 3, in the FED device in accordance with the first embodiment of the present invention, the electron beams are transferred in the gate electrode direction positioned at the center of the cell, and emitted to the phosphor layer 42 by a high voltage applied to the anode electrode 41. Here, the whole surface of the phosphor layer 42 is excited by the electron beams, to emit visible rays.

In addition, the electron beams generated at the first and second carbon nano tubes 35 and 37 are curved in the gate electrode direction in a parabola shape, thereby exciting the whole area of the phosphor layer 42 and improving uniformity of screen and luminance. Moreover, the electron beams are curved in the gate electrode direction positioned at the center of the cell and emitted in the anode electrode direction, to prevent crosstalk between the neighboring cells.

A matrix structure of an FED having the FED device will now be described with reference to FIG. 4.

FIG. 4 is a plane diagram illustrating the matrix structure of the FED in accordance with the first embodiment of the present invention.

As shown in FIG. 4, the FED includes a plurality of scan lines Scan 1 to Scan N, a plurality of data lines D₁ to Dₘ formed to cross the plurality of scan lines Scan 1 to Scan N, and FED devices formed at the cross regions between each scan line (for example, Scan 1) and each data line (for example D₁). Here, the first and second cathode electrodes 33 and 36 and the first and second carbon nano tubes 35 and 37 of the FED device are installed in each of a red pixel, a green pixel and a blue pixel, and the gate electrode 34 of the FED device is installed at the center of the cell. That is, the pair of carbon nano tubes 35 and 37 are symmetrical to each other from one gate electrode 34. The first and second carbon nano tubes 35 and 37 can be modified in various shapes, and the plurality of carbon nano tubes can be symmetrical to each other from the gate electrode 34.

A method for manufacturing the FED device in accordance with the first embodiment of the present invention will now be described with reference to FIGS. 3 and 4.

The cathode electrode line 31 is formed by forming a conductive material on the lower glass substrate 30.

The insulation layer 32 is formed on the cathode electrode line 31, and the first and second via holes are formed on the insulation layer 32 to be symmetrical to each other from the center of the cell, thereby exposing the cathode electrode line 31.

The first and second cathode electrodes 33 and 36 are formed to be symmetrical to each other from the center of the cell, by filling a conductive material in the first and second via holes and leveling the conductive material. The gate electrode 34 is formed at the center of the insulation layer 32 that is the intermediate position between the first and second cathode electrodes 33 and 36 and the center position of the cell. When the first and second cathode electrodes 33 and 36 are formed by filling the conductive material in the first and second via holes, the gate electrode 34 can be formed.

The first and second carbon nano tubes 35 and 37 are formed according to screen printing on the first and second cathode electrodes 33 and 36 formed in the first and second via holes. In the case that the first and second cathode electrodes 33 and 36 are protruded from the upper portion of the insulation layer 32, the first and second carbon nano tubes 35 and 37 can be formed on the top and side surfaces of the first and second cathode electrodes 33 and 36. In addition, the first and second carbon nano tubes 35 and 37 can be formed according to screen printing or exposure.

The interval between the gate electrode 34 and the cathode electrode 33 is narrowed, so that the driving voltage of the FED device can be lowered.

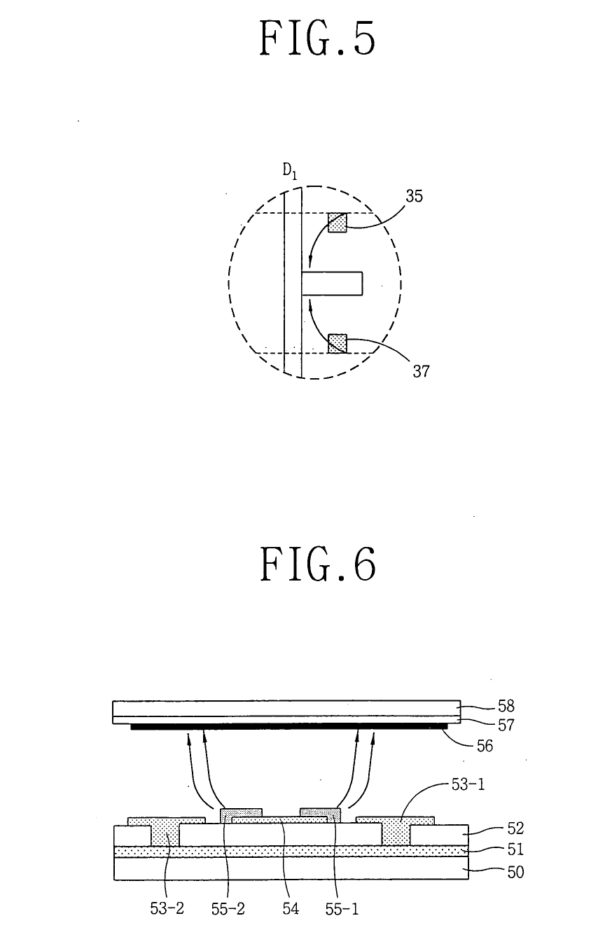

FIG. 5 is an enlarged diagram illustrating a formation part 100 of the first and second carbon nano tubes of FIG. 4, namely arrangement of the electrodes and the locus of the electron beams in one cell region.

Referring to FIG. 5, the first and second carbon nano tubes 35 and 37 formed respectively on the first and second cathode electrodes 33 and 36 connected through the first and second via holes to the cathode electrode line 31 connected to the scan line are formed to be symmetrical to each other from the gate electrode 34 connected to the data line. The electron beams emitted from the first and second carbon nano tubes 35 and 37 are curved in the gate electrode direction and emitted to the phosphor layer 42. Since the electron beams are converged on the center region of the cell by the gate electrode 34, the electron beams do not reach the neighboring cells. Accordingly, the whole surface of the phosphor layer 42 is excited, to improve luminance and contrast.

In addition, the gate electrode 34 is disposed between the first and second cathode electrodes 33 and 36 formed in the first and second via holes, and thus the interval between the gate electrode 34 and the first cathode electrode 33 (or second cathode electrode 36) is narrowed. As the interval gets narrowed, the driving voltage and power consumption of the FED device are reduced.

FIG. 6 is a cross-sectional diagram illustrating a structure of an FED device in accordance with a second embodiment of the present invention.

As illustrated in FIG. 6, the FED device includes an anode electrode 57 formed on an upper glass substrate 58, a phosphor layer 56 formed on the anode electrode 57, a gate electrode line 51 formed on a lower glass substrate 50, an insulation layer 52 formed on the gate electrode line 51 and provided with first and second via holes, a first gate electrode 53-1 formed on the insulation layer 52 and electrically connected to the gate electrode line 51 exposed through the first via hole, a second gate electrode 53-2 formed on the insulation layer 52 and electrically connected to the gate electrode line 51 exposed through the second via hole, a cathode electrode 54 positioned at the center of the FED device between the first gate electrode 53-1 and the second gate electrode 53-2, and formed on the insulation layer 52, a first carbon nano tube 55-1 formed on part of the top surface and the left surface of the cathode electrode 54, and a second carbon nano tube 55-2 formed on part of the top surface and the right surface of the cathode electrode 54.

In accordance with the second embodiment of the present invention, when a threshold voltage is applied to the cathode electrode 54 and the first and second gate electrodes 53-1 and 53-2 of the FED device, electrons are emitted from the first and second carbon nano tubes 55-1, and 55-2 formed at the left and right edges of the cathode electrode 54. The emitted electrons are accelerated in the anode electrode direction by the high voltage applied to the anode electrode 57. The accelerated electrons (electron beams) collide against the phosphor layer 56. The phosphor layer 56 is excited by the electron beams, to emit visible rays. That is, the electron beams generated at the first and second carbon nano tubes 55-1 and 55-2 formed at the edges of the cathode electrode 54 positioned at the center of the FED device are curved in the gate electrode directions installed at the left and right sides of the cathode electrode 54, and emitted in the anode electrode direction. The electron beams emitted from the first and second carbon nano tubes 55-1 and 55-2 excite the whole area of the phosphor layer 56, to improve luminance and uniformity of screen.

A method for manufacturing the FED device in accordance with the second embodiment of the present invention will now be described.

The gate electrode line 51 is formed by forming a conductive layer on the lower glass substrate 50 and patterning the conductive layer. Here, the gate electrode line 51 serves as a common line connecting the first and second gate electrodes 53-1 and 53-2.

The first and second via holes are formed by forming the insulation layer 52 on the gate electrode line 51, and etching the insulation layer 52 to partially expose the gate electrode line 51.

The first and second gate electrodes 53-1 and 53-2 are formed by filling first conductive layers in the first and second via holes of the insulation layer 52, forming second conductive layers on the first conductive layers filled in the first and second via holes, and patterning the second conductive layers.

The first carbon nano tube 55-1 is formed according to screen printing on part of the top surface and the right surface of the cathode electrode 54. The second carbon nano tube 55-2 is formed according to screen printing on part of the top surface and the left surface of the cathode electrode 54. That is, the first carbon nano tube 55-1 is formed at the right edge of the cathode electrode 54, and the second carbon nano tube 55-2 is formed at the left edge of the cathode electrode 54.

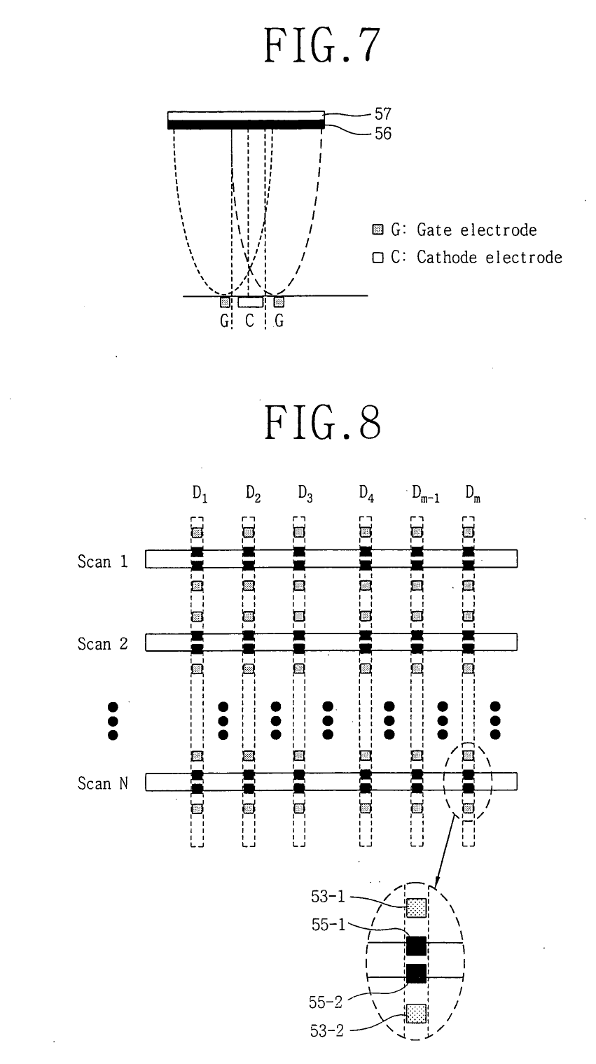

The electron beams generated by the first carbon nano tube 55-1 and the second carbon nano tube 55-2 will now be explained with reference to FIG. 7.

FIG. 7 is a cross-sectional diagram illustrating the electron beams emitted from the carbon nano tubes of the FED device in accordance with the second embodiment of the present invention.

As shown in FIG. 7, the electron beams generated by the first carbon nano tube 55-1 and the second carbon nano tube 55-2 are curved from the cathode electrode direction C to the gate electrode directions G and emitted in the anode electrode direction according to tunneling effects. That is, the locus of the electron beams generated by the first carbon nano tube 55-1 and the second carbon nano tube 55-2 is symmetrical from the center of the phosphor layer 56. Therefore, the whole area of the phosphor layer 56 is excited, to improve luminance and uniformity of screen.

FIG. 8 is a plane diagram illustrating a matrix structure of an FED having the FED device in accordance with the second embodiment of the present invention.

As depicted in FIG. 8, the FED includes a plurality of data lines D₁ to Dₘ, a plurality of scan lines Scan 1 to Scan N formed to cross the plurality of data lines D₁ to Dₘ, and FED devices formed at the cross regions between each scan line (for example, Scan 1) and each data line (for example D₁). Here, the FED devices are formed in a matrix shape. For example, the first and second gate electrodes 53-1 and 53-2 connected to the gate electrode line 51 of the FED device (cell) are installed at the upper and lower portions of the scan line (for example, Scan 1), and the first and second carbon nano tubes 55-1 and 55-2 are formed between the first and second gate electrodes 53-1 and 53-2.

On the other hand, the first carbon nano tube 55-1 can be formed on the right surface of the cathode electrode 54, and the second carbon nano tube 55-2 can be formed on the left surface of the cathode electrode 54. In addition, the first carbon nano tube 55-1 and the second carbon nano tube 55-2 can be formed merely on part of the upper portion of the cathode electrode 54.

As discussed earlier, in accordance with the present invention, the FED device converges the electron beams generated at the carbon nano tubes in the gate electrode direction, by forming the gate electrode at the center, forming the cathode electrodes at the left and right sides of the gate electrode, and forming the carbon nano tubes on the cathode electrodes.

In addition, the FED device prevents crosstalk between the neighboring cells and improves luminance, by curving the plurality of electron beams generated at the carbon nano tubes in the gate electrode direction positioned at the center, and emitting the electron beams onto the phosphor layer.

Moreover, the FED device lowers the driving voltage by narrowing the interval between the gate electrode and each cathode electrode, by forming the cathode electrodes and forming the gate electrode between the cathode electrodes.

Furthermore, the FED device improves luminance and uniformity of screen, by forming the cathode electrode at the center, forming the gate electrodes at the left and right sides of the cathode electrode, and forming the carbon nano tubes on the left and right surfaces of the cathode electrodes. That is, the electron beams emitted from the carbon nano tubes excite the whole surface of the phosphor layer, thereby improving luminance and uniformity of screen.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A field emission display device, comprising:
an anode electrode formed on a first substrate;
a phosphor layer formed on the anode electrode;
a cathode electrode line formed on a second substrate;
an insulation layer formed on the cathode electrode line;
a gate electrode formed on the insulation layer;
cathode electrodes connected to the cathode electrode line exposed through via holes formed on the insulation layer; and
carbon nano tubes formed on the cathode electrodes, respectively.

2. The field emission display device of claim 1, wherein the gate electrode is disposed at the center of the field emission display device.

3. The field emission display device of claim 1, wherein the gate electrode is formed between the cathode electrodes.

4. The field emission display device of claim 1, wherein the cathode electrodes are formed in the via holes formed on the insulation layer, and thickness of the cathode electrodes is identical to that of the insulation layer.

5. The field emission display device of claim 1, wherein the carbon nano tubes are formed on the same plane surface as that of the gate electrode.

6. A field emission display device, comprising:
an anode electrode formed on a first substrate;
a phosphor layer formed on the anode electrode;
a cathode electrode line formed on a second substrate;
an insulation layer formed on the cathode electrode line;
a gate electrode positioned at the center of the field emission display device, and formed on the insulation layer;
a first cathode electrode connected to the cathode electrode line exposed through a first via hole formed on the insulation layer;
a second cathode electrode connected to the cathode electrode line exposed through a second via hole formed on the insulation layer;
a first carbon nano tube formed on the first cathode electrode; and
a second carbon nano tube formed on the second cathode electrode.

7. The field emission display device of claim 6, wherein the gate electrode is formed between the first and second cathode electrodes.

8. The field emission display device of claim 6, wherein the first and second carbon nano tubes are formed on the same plane surface as that of the gate electrode.

9. A field emission display device, comprising:
a gate electrode line and an insulation layer sequentially formed on a lower glass substrate;
gate electrodes formed on the insulation layer, and connected to the gate electrode line exposed through via holes formed on the insulation layer;
a cathode electrode formed on the insulation layer, and disposed at the center of the field emission display device between the gate electrodes;
a first carbon nano tube formed on the right surface of the cathode electrode; and
a second carbon nano tube formed on the left surface of the cathode electrode.

10. The field emission display device of claim 9, wherein the first carbon nano tube is extended from the right surface of the cathode electrode and formed on part of the upper portion of the cathode electrode.

11. The field emission display device of claim 9, wherein the second carbon nano tube is extended from the left surface of the cathode electrode and formed on part of the upper portion of the cathode electrode.

12. The field emission display device of claim 9, wherein the first carbon nano tube is formed on the right surface of the cathode electrode, and the second carbon nano tube is formed on the left surface of the cathode electrode.

13. The field emission display device of claim 9, wherein the first and second carbon nano tubes are formed on part of the upper portion of the cathode electrode.

14. A field emission display device, comprising:
a single gate electrode positioned at the center of the field emission display device, and formed on an insulation layer;
cathode electrodes formed in via holes formed on the insulation layer; and
carbon nano tubes formed on the cathode electrodes, respectively.

15. The field emission display device of claim 14, wherein the single gate electrode is formed between the cathode electrodes.

16. A field emission display device, comprising:
a single cathode electrode positioned at the center of the field emission display device, and formed on an insulation layer;
gate electrodes formed in via holes formed on the insulation layer; and
carbon nano tubes formed on the single cathode electrode, respectively.

17. The field emission display device of claim 16, wherein the single cathode electrode is formed between the gate electrodes.

18. The field emission display device of claim 16, wherein the carbon nano tubes are formed on the both surfaces of the single cathode electrode.

19. The field emission display device of claim 16, wherein the carbon nano tubes are formed on part of the upper portion of the single cathode electrode, respectively.
